(19) United States
(12) Patent Application Publication
(10) Pub. No.: US 2026/0061796 A1
(43) Pub. Date: Mar. 5, 2026

(54) VEHICLE DAMPING CONTROL METHOD AND DAMPING CONTROL SYSTEM

(71) Applicant: TOYOTA JIDOSHA KABUSHIKI KAISHA, Toyota-shi (JP)

(72) Inventor: Hiroki FURUTA, Susono-shi (JP)

(73) Assignee: TOYOTA JIDOSHA KABUSHIKI KAISHA, Toyota-shi (JP)

(21) Appl. No.: 19/292,858

(22) Filed: Aug. 6, 2025

(30) Foreign Application Priority Data
Sep. 5, 2024 (JP) 2024-152912

(51) Int. Cl. B60G 17/016; B60G 17/015; B60G 17/018; B60G 17/06

(52) U.S. Cl. CPC B60G 17/016; B60G 17/0152; B60G 17/018; B60G 17/06; B60G 2400/252; B60G 2400/91; B60G 2600/1873; B60G 2600/70

(57) ABSTRACT

A method includes calculating a predicted passing position of each wheel of a vehicle after a preview period from a current time, acquiring a parameter related to vertical motion of each wheel at the predicted passing position from a parameter map, calculating a left and right wheel in-phase input of a first wheel and a second wheel and a left and right wheel anti-phase input of the first wheel and the second wheel, and calculating each control amount of an actuator that controls suspension strokes of the first and second wheels based on the left and right wheel anti-phase input and the left and right wheel in-phase input.

### CROSS-REFERENCE TO RELATED APPLICATION

This application claims priority to Japanese Patent Application No. 2024-152912 filed on Sep. 5, 2024. The disclosure of the above-identified application, including the specification, drawings, and claims, is incorporated by reference herein in its entirety.

### BACKGROUND

### 1. Technical Field

The present disclosure relates to a method and a system for performing damping control of a vehicle using a control map.

### 2. Description of Related Art

US 2018-0154723 A discloses a road surface displacement map representing a correspondence relationship between a road surface displacement (road roughness) and a position. Damping control is performed by utilizing such a road surface displacement map. Specifically, a road surface displacement at a predetermined position ahead of a vehicle is recognized in advance from the road surface displacement map. A control amount of an active suspension is calculated in advance in accordance with the road surface displacement recognized in advance. Then, by controlling the active suspension at a timing at which a wheel passes through the predetermined position, damping of the vehicle is effectively reduced.

### SUMMARY

In US 2018-0154723 A, upon creation of the road surface displacement map, filtering processing of cutting out frequencies significantly below a vehicle body frequency and frequencies significantly above the vehicle body frequency from road condition data is performed. Here, the road condition data can be referred to as data of parameters related to the road surface displacement. Further, the data of the parameters related to the road surface displacement can be also referred to as data of parameters related to vertical motion of wheels that are in contact with the road surface.

In the present disclosure, damping control using a control map representing a correspondence relationship between a position and a parameter related to vertical motion of each wheel of a vehicle will be considered. Such a control map can be created, for example, using time-series data of the parameter related to the vertical motion of each wheel. However, the parameter related to vertical motion of each wheel includes an extremely low frequency component resulting from elevation change, and the like. Thus, upon creation of the control map, it is preferable to perform filtering processing using a high-pass filter to cut out the extremely low frequency component from the parameter related to the vertical motion of each wheel. However, if a high-pass filter stronger than necessary is used, a left and right wheel anti-phase input resulting from vertical displacements that are different between the left and right wheels is also cut out.

In a case where damping control is performed using a control map created from time-series data in which the left and right wheel anti-phase input is cut out, the left and right wheel anti-phase input is not reflected in the damping control, and an effect of control degrades. This problem is resolved by using a weak high-pass filter in the filtering processing. However, in this case, a left and right wheel in-phase input which is likely to be affected by elevation change and which results from vertical displacements that are the same between the left and right wheels remains. As a result, there is a possibility that in damping control using the control map, an effect of control may degrade due to an excessive control amount to cancel out the left and right wheel in-phase input.

The present disclosure provides a technique capable of, in a case where damping control using a control map representing a correspondence relationship between a position and a parameter related to vertical motion of each wheel of a vehicle is performed, appropriately reflecting a left and right wheel anti-phase input and a left and right wheel in-phase input in the damping control.

A first aspect of the present disclosure is a method for performing damping control of a vehicle using a control map, to be executed by a computer, and has the following features. The control map includes a parameter map representing a correspondence relationship between a position and a parameter related to vertical motion of each wheel of the vehicle. The parameter map is created or updated through filtering processing performed on time-series data of the parameter related to the vertical motion of each wheel of the vehicle. The filtering processing includes filtering processing using a first high-pass filter that cuts out a frequency component equal to or less than a first frequency from the parameter related to the vertical motion of each wheel of the vehicle. The method includes calculating a predicted passing position of each wheel of the vehicle after a preview period from a current time while the vehicle is traveling, acquiring the parameter related to the vertical motion of each wheel at the predicted passing position of each wheel of the vehicle from the parameter map, calculating a left and right wheel in-phase input resulting from vertical displacements that are the same between a first wheel of the vehicle and a second wheel of the vehicle which constitutes left and right wheels with the first wheel, based on a parameter related to vertical motion of the first wheel at the predicted passing position of the first wheel and a parameter related to vertical motion of the second wheel at the predicted passing position of the second wheel, calculating a left and right wheel anti-phase input resulting from vertical displacements that are different between the first wheel and the second wheel based on the parameter related to the vertical motion of the first wheel at the predicted passing position of the first wheel and the parameter related to the vertical motion of the second wheel at the predicted passing position of the second wheel, and calculating each control amount of an actuator configured to control suspension strokes of the first wheel and the second wheel based on the left and right wheel anti-phase input of the first wheel and the second wheel and the left and right wheel in-phase input of the first wheel and the second wheel.

The method according to the first aspect of the present disclosure may further include determining whether or not additional filtering processing on the left and right wheel in-phase input of the first wheel and the second wheel is required, wherein the additional filtering processing may include filtering processing using a second high-pass filter that cuts out a frequency component equal to or less than a second frequency higher than the first frequency from the left and right wheel in-phase input of the first wheel and the second wheel, and the method may further include, in a case where it is determined that the additional filtering processing is required, calculating each control amount of the actuator configured to control the suspension strokes of the first wheel and the second wheel based on the left and right wheel anti-phase input of the first wheel and the second wheel and the left and right wheel in-phase input of the first wheel and the second wheel subjected to filtering processing that includes the additional filtering processing.

In the method according to the first aspect of the present disclosure, determining whether or not the additional filtering processing on the left and right wheel in-phase input of the first wheel and the second wheel is required may include determining whether or not a filter application condition is satisfied, and determining whether or not the filter application condition is satisfied may include determining that the filter application condition is satisfied in a case where at least one of a condition that the left and right wheel in-phase input of the first wheel and the second wheel is equal to or greater than an upper limit value or a condition that a moving average of the left and right wheel in-phase input of the first wheel and the second wheel is equal to or greater than an upper limit value, is satisfied.

The method according to the first aspect of the present disclosure may further include decreasing the preview period such that a phase lead of the left and right wheel in-phase input of the first wheel and the second wheel is canceled out, the phase lead being in accordance with a time constant of the second high-pass filter used in the additional filtering processing.

The method according to the first aspect of the present disclosure may further include calculating a left and right wheel in-phase input resulting from vertical displacements that are the same between a third wheel of the vehicle, which constitutes front and rear wheels with the first wheel and the second wheel, and a fourth wheel of the vehicle, which constitutes left and right wheels with the third wheel, based on a parameter related to vertical motion of the third wheel at the predicted passing position of the third wheel and a parameter related to vertical motion of the fourth wheel at the predicted passing position of the fourth wheel, calculating a left and right wheel anti-phase input resulting from vertical displacements that are different between the third wheel and the fourth wheel based on the parameter related to the vertical motion of the third wheel at the predicted passing position of the third wheel and the parameter related to the vertical motion of the fourth wheel at the predicted passing position of the fourth wheel, calculating a left and right wheel in-phase and front and rear wheel in-phase input resulting from vertical displacements that are the same between the first wheel and the second wheel and are the same between the first wheel and the second wheel, and the third wheel and the fourth wheel, based on the left and right wheel in-phase input of the first wheel and the second wheel and the left and right wheel in-phase input of the third wheel and the fourth wheel, and calculating a left and right wheel in-phase and front and rear wheel anti-phase input resulting from vertical displacements that are the same between the first wheel and the second wheel and are different between the first wheel and the second wheel, and the third wheel and the fourth wheel, based on the left and right wheel in-phase input of the first wheel and the second wheel and the left and right wheel anti-phase input of the third wheel and the fourth wheel, wherein calculating each control amount of the actuator that controls the suspension strokes of the first wheel and the second wheel may include calculation of a control amount based on the left and right wheel anti-phase input of the first wheel and the second wheel and the left and right wheel in-phase and front and rear wheel in-phase input, and calculation of a control amount based on the left and right wheel anti-phase input of the first wheel and the second wheel and the left and right wheel in-phase and front and rear wheel anti-phase input.

The method according to the first aspect of the present disclosure may further include determining whether or not additional filtering processing on the left and right wheel in-phase input of the first wheel and the second wheel is required, wherein the additional filtering processing may include filtering processing using a second high-pass filter that cuts out a frequency component equal to or less than a second frequency higher than the first frequency from the left and right wheel in-phase input of the first wheel and the second wheel, wherein determining whether or not the additional filtering processing on the left and right wheel in-phase input of the first wheel and the second wheel is required may include determining whether or not additional filtering processing on the left and right wheel in-phase and front and rear wheel in-phase input is required, and determining whether or not additional filtering processing on the left and right wheel in-phase and front and rear wheel anti-phase input is required. The method may further include, in a case where it is determined that the additional filtering processing is required, calculating each control amount of the actuator configured to control the suspension strokes of the first wheel and the second wheel based on the left and right wheel anti-phase input of the first wheel and the second wheel, the left and right wheel in-phase and front and rear wheel in-phase input subjected to filtering processing that includes the additional filtering processing, the left and right wheel anti-phase input of the first wheel and the second wheel, and the left and right wheel in-phase and front and rear wheel anti-phase input subjected to filtering processing that includes the additional filtering processing.

In the method according to the first aspect of the present disclosure, the additional filtering processing on the left and right wheel in-phase and front and rear wheel in-phase input may include filtering processing using a third high-pass filter that cuts out a frequency component equal to or less than a third frequency higher than the first frequency, and the additional filtering processing on the left and right wheel in-phase and front and rear wheel anti-phase input may include filtering processing using a fourth high-pass filter that cuts out a frequency component equal to or less than a fourth frequency between the first frequency and the third frequency.

The method according to the first aspect of the present disclosure may further include decreasing the preview period such that a phase lead of the left and right wheel in-phase and front and rear wheel in-phase input is canceled out, the phase lead being in accordance with a time constant of the third high-pass filter used in the additional filtering processing performed on the left and right wheel in-phase and front and rear wheel in-phase input.

The method according to the first aspect of the present disclosure may further include decreasing the preview period such that a phase lead of the left and right wheel in-phase and front and rear wheel anti-phase input is canceled out, the phase lead being in accordance with a time constant of the fourth high-pass filter used in the additional filtering processing performed on the left and right wheel in-phase and front and rear wheel anti-phase input.

A second aspect of the present disclosure is a system configured to perform damping control of a vehicle using a control map and has the following features. The system includes an actuator configured to control a suspension stroke of each wheel of the vehicle, one or a plurality of storage devices in which the control map is stored, and one or a plurality of processors configured to perform damping control processing of the vehicle by controlling the actuator based on the control map. The control map includes a parameter map representing a correspondence relationship between a position and a parameter related to vertical motion of each wheel of the vehicle. The parameter map is created or updated through filtering processing on time-series data of the parameter related to the vertical motion of each wheel of the vehicle. The filtering processing includes filtering processing of cutting out a frequency component equal to or less than a first frequency from the parameter related to the vertical motion of each wheel of the vehicle. The damping control processing includes calculating a predicted passing position of each wheel of the vehicle after a preview period from a current time while the vehicle is traveling, acquiring a parameter related to vertical motion of each wheel at the predicted passing position of each wheel of the vehicle from the parameter map, calculating a left and right wheel in-phase input resulting from vertical displacements that are the same between a first wheel of the vehicle and a second wheel of the vehicle which constitutes left and right wheels with the first wheel based on a parameter related to vertical motion of the first wheel at the predicted passing position of the first wheel and a parameter related to vertical motion of the second wheel at the predicted passing position of the second wheel, calculating a left and right wheel anti-phase input resulting from vertical displacements that are different between the first wheel and the second wheel based on the parameter related to the vertical motion of the first wheel at the predicted passing position of the first wheel and the parameter related to the vertical motion of the second wheel at the predicted passing position of the second wheel, and calculating each control amount of the actuator configured to control suspension strokes of the first wheel and the second wheel based on the left and right wheel anti-phase input of the first wheel and the second wheel and the left and right wheel in-phase input of the first wheel and the second wheel.

In the system according to the second aspect of the present disclosure, the damping control processing may further include determining whether or not additional filtering processing on the left and right wheel in-phase input of the first wheel and the second wheel is required, wherein the additional filtering processing may include filtering processing using a second high-pass filter that cuts out a frequency component equal to or less than a second frequency higher than the first frequency from the left and right wheel in-phase input of the first wheel and the second wheel, and the damping control processing may further include, in a case where it is determined that the additional filtering processing is required, calculating each control amount of the actuator configured to control the suspension strokes of the first wheel and the second wheel based on the left and right wheel anti-phase input of the first wheel and the second wheel and the left and right wheel in-phase input of the first wheel and the second wheel subjected to filtering processing that includes the additional filtering processing.

According to the present disclosure, damping control processing is performed using a parameter map created or updated based on time-series data in which a frequency component higher than the first frequency remains among the parameter related to the vertical motion of each wheel of the vehicle. In the damping control processing, the parameter related to the vertical motion of each wheel at the predicted passing position of each wheel is read from the parameter map, and a left and right wheel in-phase input of the first wheel and the second wheel, and a left and right wheel anti-phase input of the first wheel and the second wheel are calculated. Further, each control amount of the actuator that controls the suspension strokes of the first wheel and the second wheel is calculated based on the left and right wheel anti-phase input of the first wheel and the second wheel and the left and right wheel in-phase input of the first wheel and the second wheel. It is therefore possible to appropriately reflect the left and right wheel in-phase input and the left and right wheel anti-phase input in the damping control.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view illustrating a configuration example of a vehicle according to an embodiment;

FIG. 2 is a conceptual diagram illustrating a configuration example of a suspension according to the embodiment;

FIG. 3 is a flowchart indicating an example of unsprung displacement calculation processing;

FIG. 4 is a block diagram illustrating a configuration example of a vehicle control system according to the embodiment;

FIG. 5 is a block diagram illustrating an example of driving environment information according to the embodiment;

FIG. 6 is a block diagram illustrating a configuration example of a map management system according to the embodiment;

FIG. 7 is a conceptual diagram for explaining an unsprung displacement map according to the embodiment;

FIG. 8 is a flowchart indicating map generation and updating processing according to the embodiment;

FIG. 9 is a conceptual diagram for explaining preview control utilizing the unsprung displacement map according to the embodiment; and

FIG. 10 is a flowchart indicating the preview control utilizing the unsprung displacement map according to the embodiment.

### DETAILED DESCRIPTION OF EMBODIMENTS

An embodiment of the present disclosure will be described with reference to the accompanying drawings.

### 1. Suspension and Vertical Motion Parameter

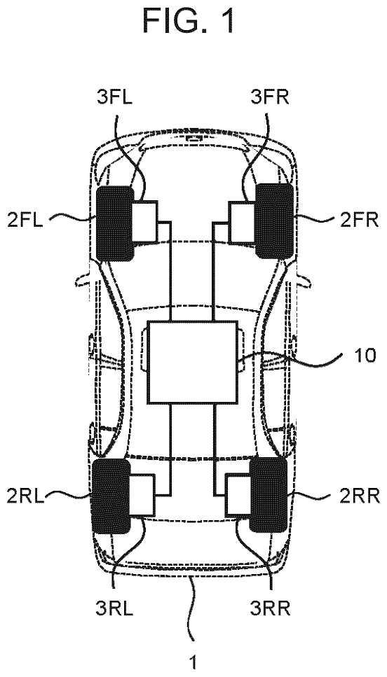

FIG. 1 is a schematic view illustrating a configuration example of a vehicle 1 according to the embodiment. The vehicle 1 may be an autonomous driving vehicle. The vehicle 1 includes a wheel 2 and a suspension 3. The wheel 2 includes a front left wheel 2FL, a front right wheel 2FR, a rear left wheel 2RL and a rear right wheel 2RR. The front left wheel 2FL and the front right wheel 2FR constitute left and right wheels on a front axle side, and the rear left wheel 2RL and the rear right wheel 2RR constitute left and right wheels on a rear axle side. Suspensions 3FL, 3FR, 3RL and 3RR are respectively provided at the front left wheel 2FL, the front right wheel 2FR, the rear left wheel 2RL, the rear right wheel 2RR. In the following description, in a case where it is not necessary to particularly distinguish, each wheel will be referred to as the wheel 2, and each suspension will be referred to as the suspension 3.

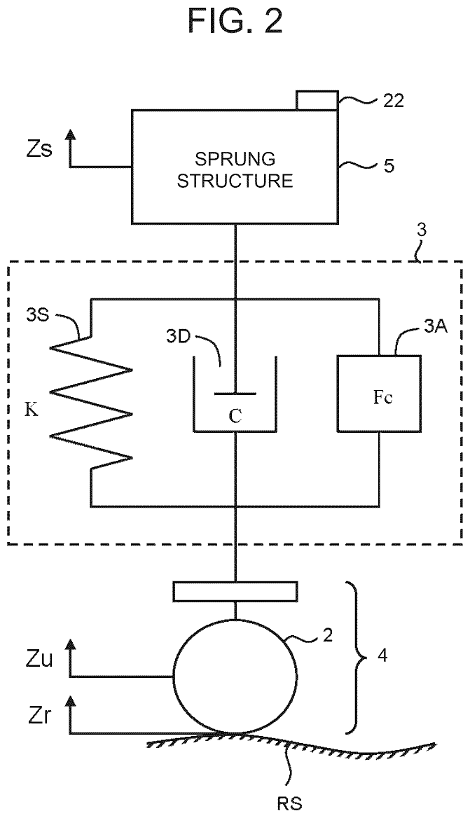

FIG. 2 is a conceptual diagram illustrating a configuration example of the suspension 3. The suspension 3 is provided to connect an unsprung structure 4 and a sprung structure 5 of the vehicle 1. The unsprung structure 4 includes the wheel 2. The suspension 3 includes a spring 3S, a damper (shock absorber) 3D, and an actuator 3A. The spring 3S, the damper 3D and the actuator 3A are provided in parallel between the unsprung structure 4 and the sprung structure 5. A spring constant of the spring 3S is K. A damping coefficient of the damper 3D is C. Damping force of the damper 3D may be variable. The actuator 3A causes control force Fc in a vertical direction to act between the unsprung structure 4 and the sprung structure 5.

Here, terms will be defined. A “road surface displacement Zr” is a displacement in the vertical direction of a road surface RS. An “unsprung displacement Zu” is a displacement in the vertical direction of the unsprung structure 4. A “sprung displacement Zs” is a displacement in the vertical direction of the sprung structure 5. An “unsprung speed Zu′” is a speed in the vertical direction of the unsprung structure 4. A “sprung speed Zs′” is a speed in the vertical direction of the sprung structure 5. An “unsprung acceleration Zu″” is an acceleration in the vertical direction of the unsprung structure 4. A “sprung acceleration Zs″” is an acceleration in the vertical direction of the sprung structure 5. Note that a sign of each parameter is positive in a case of upward and is negative in a case of downward.

The wheel 2 moves on the road surface RS. In the following description, a parameter related to vertical motion of the wheel 2 will be referred to a “vertical motion parameter”. Examples of the vertical motion parameter include the road surface displacement Zr, the unsprung displacement Zu, the unsprung speed Zu′, the unsprung acceleration Zu″, the sprung displacement Zs, the sprung speed Zs′, the sprung acceleration Zs″, and the like, described above. The vertical motion parameter can be also referred to as a “road surface displacement parameter” related to the road surface displacement Zr.

As one example, a case will be considered in the following description where a road surface displacement related value is the unsprung displacement Zu. In a case where the description is generalized, the “unsprung displacement” in the following description will be read as the “road surface displacement related value”.

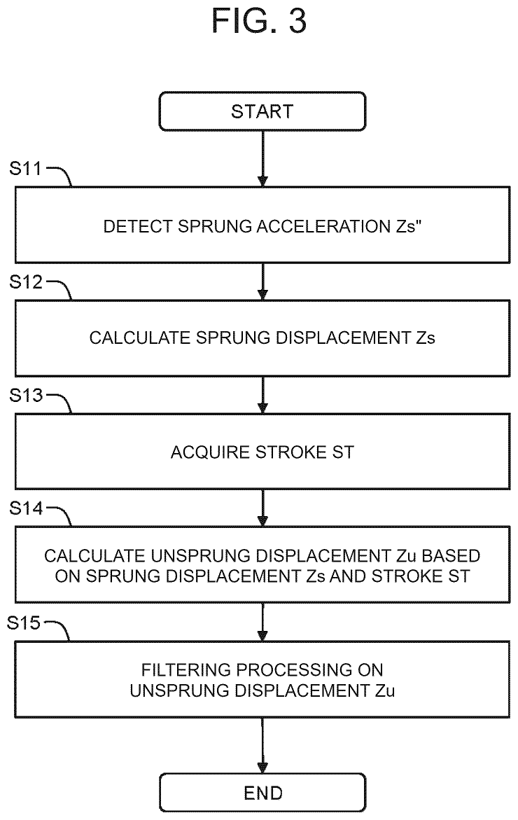

FIG. 3 is a flowchart indicating one example of unsprung displacement calculation processing.

In step S11, the sprung acceleration Zs″ is detected by a sprung acceleration sensor 22 provided at the sprung structure 5. In step S12, the sprung displacement Zs is calculated by second-order integrating the sprung acceleration Zs″.

In step S13, a stroke ST (=Zs−Zu) that is a relative displacement between the sprung structure 5 and the unsprung structure 4 is acquired. For example, the stroke ST is detected by a stroke sensor provided at the suspension 3. As another example, the stroke ST may be estimated based on the sprung acceleration Zs″ by an observer configured based on a single-wheel two-degrees-of-freedom model.

In step S14, a difference between the sprung displacement Zs and the stroke ST is calculated as the unsprung displacement Zu.

As another example, the unsprung acceleration Zu″ may be detected by the unsprung acceleration sensor, and the unsprung displacement Zu may be calculated from the unsprung acceleration Zu″.

In step S15, filtering processing is performed on time-series data of the unsprung displacement Zu. The unsprung displacement Zu includes an extremely low frequency component (for example, a component equal to or less than 0.5 Hz) resulting from elevation change, and the like. However, this extremely low frequency component also includes a left and right wheel anti-phase input. Thus, in step S15, filtering processing is performed using a first high-pass filter for cutting out a component equal to or less than a first frequency (for example, 0.2 Hz) and leaving a frequency component including the left and right wheel anti-phase input. In this case, while an extremely low frequency component resulting from elevation change, and the like, also remains, whether or not to cut out this extremely low frequency component is determined in damping control processing which will be described later.

### 2. Vehicle Control System

### 2-1. Configuration Example

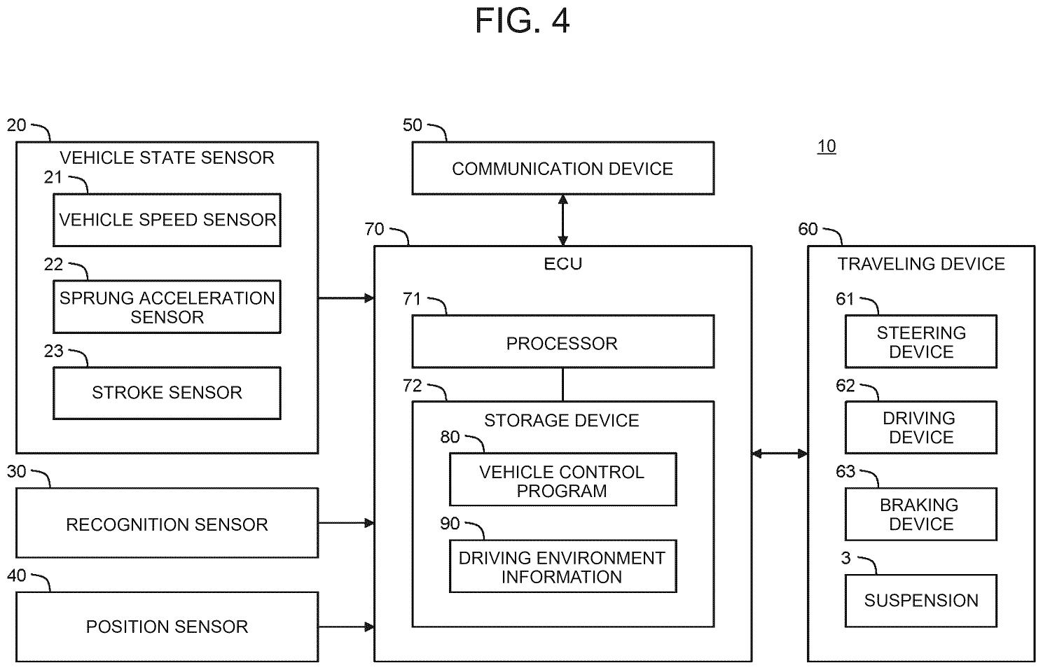

FIG. 4 is a block diagram illustrating a configuration example of a vehicle control system 10 according to the embodiment. The vehicle control system 10 is mounted on the vehicle 1 and controls the vehicle 1. The vehicle control system 10 includes a vehicle state sensor 20, a recognition sensor 30, a position sensor 40, a communication device 50, a traveling device 60 and a control device 70.

The vehicle state sensor 20 detects a state of the vehicle 1. The vehicle state sensor 20 includes a vehicle speed sensor (wheel speed sensor) 21 that detects a vehicle speed V of the vehicle 1, a sprung acceleration sensor 22 that detects the sprung acceleration Zs″, and the like. The vehicle state sensor 20 may include a stroke sensor 23 that detects the stroke ST. The vehicle state sensor 20 may include an unsprung acceleration sensor. In addition, the vehicle state sensor 20 may include a lateral acceleration sensor, a yaw rate sensor, a steering angle sensor, and the like.

The recognition sensor 30 recognizes (detects) a surrounding situation of the vehicle 1. Examples of the recognition sensor can include a camera, a laser imaging detection and ranging (LIDAR), a radar, and the like.

The position sensor 40 detects a position and an azimuth of the vehicle 1. For example, the position sensor 40 includes a global navigation satellite system (GNSS).

The communication device 50 performs communication with outside of the vehicle 1.

The traveling device 60 includes a steering device 61, a driving device 62, a braking device 63, and the suspension 3 (see FIG. 2). The steering device 61 steers the wheel 2. For example, the steering device 61 includes an electric power steering (EPS) device. The driving device 62 is a power source that generates driving force. Examples of the driving device 62 can include an engine, an electric motor, an in-wheel motor, and the like. The braking device 63 generates braking force.

The control device 70 is a computer that controls the vehicle 1. The control device 70 includes one or a plurality of processors 71 (hereinafter, simply referred to as a processor 71), and one or a plurality of storage devices 72 (hereinafter, simply referred to as a storage device 72). The processor 71 executes various kinds of processing. For example, the processor 71 includes a central processing unit (CPU). The storage device 72 stores various kinds of information necessary for processing by the processor 71. Examples of the storage device 72 can include a volatile memory, a non-volatile memory, a hard disk drive (HDD), a solid state drive (SSD), and the like. The control device 70 may include one or a plurality of electronic control units (ECUs).

A vehicle control program 80, which is a computer program for controlling the vehicle 1, is executed by the processor 71. The vehicle control program 80 is stored in the storage device 72. Alternatively, the vehicle control program 80 may be recorded in a computer-readable recording medium. Functions of the control device 70 are implemented by the processor 71 executing the vehicle control program 80.

### 2-2. Driving Environment Information

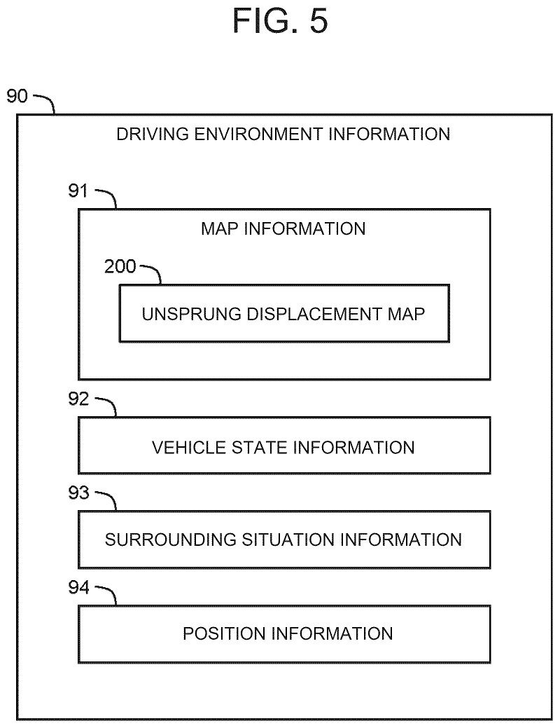

FIG. 5 is a block diagram illustrating one example of driving environment information 90 indicating a driving environment of the vehicle 1. The driving environment information 90 is stored in the storage device 72. The driving environment information 90 includes map information 91, vehicle state information 92, surrounding situation information 93, and position information 94.

The map information 91 includes a typical navigation map. The map information 91 may indicate arrangement of lanes, a road shape, and the like. The map information 91 may include position information of a white line, a traffic light, a sign, a landmark, and the like. The map information 91 can be obtained from a map database. Note that the map database may be mounted on the vehicle 1 or may be stored in an external management server. In the latter case, the control device 70 performs communication with the management server to acquire necessary map information 91.

The map information 91 further includes an “unsprung displacement map 200”. Details of the unsprung displacement map 200 will be described later.

The vehicle state information 92 is information indicating a state of the vehicle 1. The control device 70 acquires the vehicle state information 92 from the vehicle state sensor 20. For example, the vehicle state information 92 includes a vehicle speed V, the sprung acceleration Zs″, the stroke ST, a lateral acceleration, a yaw rate, a steering angle, and the like. The vehicle speed V may be calculated from a vehicle position detected by the position sensor 40. The control device 70 may calculate the unsprung displacement Zu using the method indicated in FIG. 3. In this case, the vehicle state information 92 includes the unsprung displacement Zu calculated by the control device 70.

The surrounding situation information 93 is information indicating a surrounding situation of the vehicle 1. The control device 70 recognizes the surrounding situation of the vehicle 1 using the recognition sensor 30 to acquire the surrounding situation information 93. For example, the surrounding situation information 93 includes image information captured by a camera. As another example, the surrounding situation information 93 includes point cloud information obtained by a LIDAR.

The surrounding situation information 93 further includes “object information” regarding a surrounding object of the vehicle 1. Examples of the object can include a pedestrian, a bicycle, another vehicle (such as a preceding vehicle and a parked vehicle), a road structure (such as a white line, a curb, a guardrail, a wall, a center median, and a roadside structure), a sign, a pole, an obstacle, and the like. The object information indicates a relative position and a relative speed of the object with respect to the vehicle 1. For example, it is possible to identify the object and calculate a relative position of the object by analyzing image information obtained by the camera. Further, it is also possible to identify the object and acquire a relative position and a relative speed of the object based on point cloud information obtained by the LIDAR.

The position information 94 is information indicating a position and an azimuth of the vehicle 1. The control device 70 acquires the position information 94 from a detection result by the position sensor 40. Further, the control device 70 may acquire high-accuracy position information 94 through well-known self-position estimation processing (localization) utilizing the object information and the map information 91.

### 2-3. Vehicle Control

The control device 70 executes vehicle traveling control of controlling traveling of the vehicle 1. The vehicle traveling control includes steering control, driving control and braking control. The control device 70 executes the vehicle traveling control by controlling the traveling device 60 (the steering device 61, the driving device 62, and the braking device 63). The control device 70 may perform driver assistance control of assisting driving of the vehicle 1 based on the driving environment information 90. Examples of the driver assistance control can include lane keeping control, collision avoidance control, autonomous driving control, and the like.

Further, the control device 70 controls the suspension 3. Typically, the control device 70 performs damping control of controlling the suspension 3 to dampen vibration of the vehicle 1. For example, the control device 70 controls the actuator 3A to generate control force Fc in the vertical direction between the unsprung structure 4 and the sprung structure 5 (see FIG. 2). As another example, the control device 70 may perform variable control on damping force of the damper 3D. The damping control includes “preview control” which will be described later.

### 3. Map Management System

### 3-1. Configuration Example

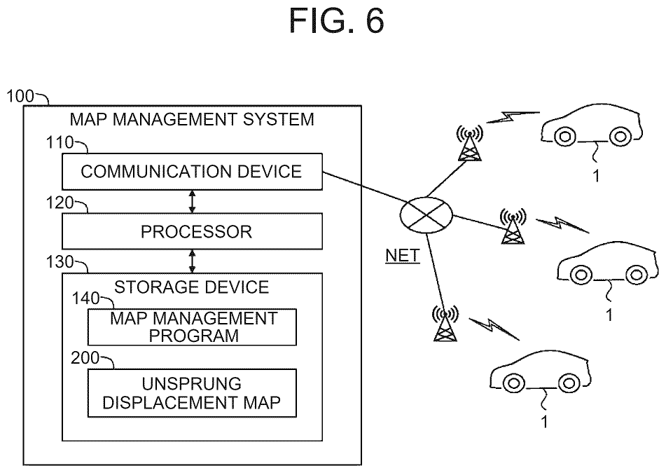

FIG. 6 is a block diagram illustrating a configuration example of a map management system 100 according to the embodiment. The map management system 100 is a computer that manages various kinds of map information. Management of the map information includes generation, updating, provision, distribution, and the like, of the map information. Typically, the map management system 100 is a management server on cloud. The map management system 100 may be a distributed system in which a plurality of servers performs distributed processing.

The map management system 100 includes a communication device 110. The communication device 110 is connected to a communication network NET. For example, the communication device 110 performs communication with a number of vehicles 1 via the communication network NET.

The map management system 100 further includes one or a plurality of processors 120 (hereinafter, simply referred to as a processor 120) and one or a plurality of storage devices 130 (hereinafter, simply referred to as a storage device 130). The processor 120 executes various kinds of information processing. For example, the processor 120 includes a CPU. The storage device 130 stores various kinds of map information. Further, the storage device 130 stores various kinds of information necessary for processing by the processor 120. Examples of the storage device 130 can include a volatile memory, a non-volatile memory, an HDD, an SSD, and the like.

The map management program 140, which is a computer program for map management, is executed by the processor 120. The map management program 140 is stored in the storage device 130. Alternatively, the map management program 140 may be recorded in a computer-readable recording medium. Functions of the map management system 100 are implemented by the processor 120 executing the map management program 140.

The processor 120 performs communication with the vehicle control system 10 of the vehicle 1 via the communication device 110. The processor 120 collects various kinds of information from the vehicle control system 10 and generates and updates map information based on the collected information. Further, the processor 120 distributes the map information to the vehicle control system 10. Still further, the processor 120 provides the map information in response to a request from the vehicle control system 10.

### 3-2. Unsprung Displacement Map

One of the map information to be managed by the map management system 100 is an “unsprung displacement map (vertical motion parameter map) 200”. The unsprung displacement map 200 is a map regarding the unsprung displacement Zu (vertical motion parameter). The unsprung displacement map 200 is stored in the storage device 130. The unsprung displacement map 200 is one example of the “control map”.

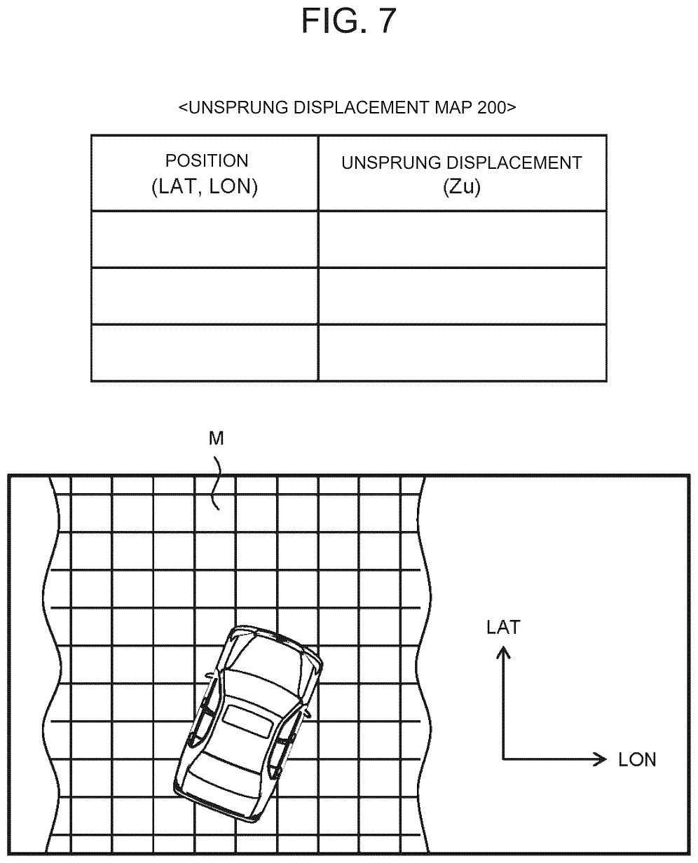

FIG. 7 is a conceptual diagram for explaining the unsprung displacement map 200. An absolute coordinate system in a horizontal plane is, for example, defined by a latitude direction and a longitude direction. A position on the horizontal plane is, for example, defined by latitude LAT and longitude LON. The unsprung displacement map 200 represents a correspondence relationship between the position (LAT, LON) and the unsprung displacement Zu. In other words, the unsprung displacement map 200 represents the unsprung displacement Zu as a function of the position (LAT, LON).

A road region is, for example, separated in a mesh shape on the horizontal plane. In other words, the road region is separated into a plurality of unit areas M on the horizontal plane. The unit area M is, for example, a square. A length of one side of the square is, for example, 10 cm. The unsprung displacement map 200 represents a correspondence relationship between a position of the unit area M and the unsprung displacement Zu. The position of the unit area M may be defined by a representative position (for example, a central position) of the unit area M or may be defined by a range (a latitude range, a longitude range) of the unit area M. The unsprung displacement Zu of the unit area M is, for example, an average value of the unsprung displacements Zu acquired within the unit area M. As the unit area M is made smaller, resolution of the unsprung displacement map 200 increases.

Even in a case where the wheel 2 passes through the same position (LAT, LON) on the road, the calculated unsprung displacement Zu can differ depending on a traveling direction of the vehicle 1. For example, a case will be considered where there is a rut on the road. There is a possibility that the unsprung displacement Zu may differ depending on whether the wheel 2 moves along the rut or crosses the rut. Thus, a traveling direction p of the vehicle 1 may be acquired from the position information 94, and different unsprung displacement maps 200 may be generated and updated for each traveling direction φ.

### 3-3. Map Generation and Updating Processing

The processor 120 collects information from a number of vehicles 1 via the communication device 110. Then, the processor 120 generates and updates the unsprung displacement map 200 based on the information collected from a number of vehicles 1. An example of map generation and updating processing will be described in further detail below.

A position in the unsprung displacement map 200 is a position through which the wheel 2 has passed. The position of each wheel 2 is calculated based on the above-described position information 94. Specifically, a relative positional relationship between a reference point of the vehicle position and each wheel 2 in the vehicle 1 is known information. The position of each wheel 2 can be calculated based on a vehicle position indicated by the relative positional relationship and the position information 94.

The unsprung displacement Zu is calculated using the method as indicated in FIG. 3. In other words, the sprung displacement Zs and the stroke ST are obtained by using the vehicle state sensor 20 mounted on the vehicle 1. The sprung displacement Zs and the stroke ST will be referred to as “sensor-based information” for convenience sake. The unsprung displacement Zu is calculated based on this sensor-based information.

For example, the control device 70 of the vehicle control system 10 associates the position of the wheel 2 and the sensor-based information of the same timing. Then, the control device 70 transmits a set of time-series data of the position of the wheel 2 and time-series data of the sensor-based information to the map management system 100. The processor 120 of the map management system 100 calculates the unsprung displacement Zu based on the received sensor-based information. Further, the processor 120 generates and updates the unsprung displacement map 200 based on the time-series data of the position of the wheel 2 and the time-series data of the unsprung displacement Zu.

Note that in a case where the unsprung displacement Zu is calculated in the map management system 100, there is no restriction of a processing period, and thus, filtering processing can be performed using a zero-phase filter. Utilization of the zero-phase filter makes it possible to prevent “phase shifting”.

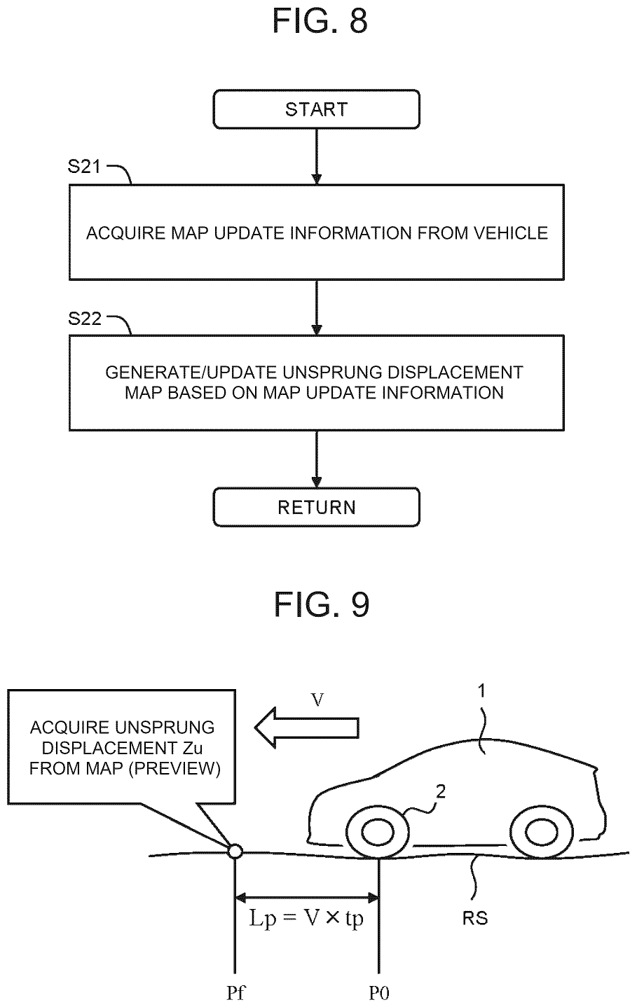

FIG. 8 is a flowchart indicating overview of the map generation and updating processing according to the embodiment.

In step S21, the processor 120 of the map management system 100 acquires “map update information” from the vehicle 1 (vehicle control system 10) via the communication device 110. The map update information includes time-series data of a position (wheel position) of the vehicle 1. Further, the map update information includes time-series data of the sensor-based information (for example, the sprung displacement Zs and the stroke ST) necessary for calculating the unsprung displacement Zu. Alternatively, the map update information may include time-series data of the unsprung displacement Zu calculated by the control device 70 of the vehicle control system 10.

In step S22, the processor 120 of the map management system 100 generates and updates the unsprung displacement map 200 based on the map update information.

### 3-4. Modification

The vehicle control system 10 of the vehicle 1 may hold a database of the unsprung displacement map 200 and generate and update the unsprung displacement map 200 of the vehicle control system 10. In other words, the map management system 100 may be included in the vehicle control system 10.

### 4. Damping Control Processing Utilizing Unsprung Displacement Map

The control device 70 of the vehicle control system 10 performs communication with the map management system 100 via the communication device 50. The control device 70 acquires the unsprung displacement map 200 of an area including a current position of the vehicle 1 from the map management system 100. The unsprung displacement map 200 is stored in the storage device 72. Then, the control device 70 executes “preview control” which is one type of the damping control based on the unsprung displacement map 200.

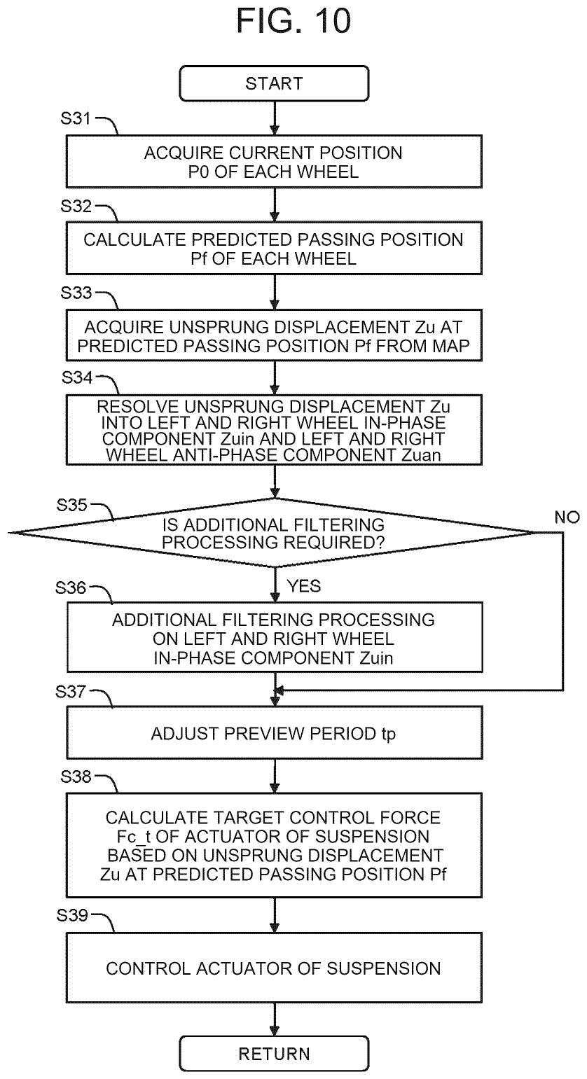

FIG. 9 is a conceptual diagram for explaining the preview control. FIG. 10 is a flowchart indicating the preview control. The preview control will be described with reference to FIG. 9 and FIG. 10.

In step S31, the processor 71 acquires a current position P0 of each wheel 2. A relative positional relationship between a reference point of the vehicle position and each wheel 2 in the vehicle 1 is known information. The position of each wheel 2 can be calculated based on the vehicle position indicated by the relative positional relationship and the position information 94.

In step S32, the processor 71 calculates a predicted passing position Pf of the wheel 2 after a preview period tp. The preview period tp is set at equal to or longer than a period required for calculation processing and communication processing that are necessary until the actuator 3A of the suspension 3 is activated. The preview period tp may be fixed or may be variable in accordance with situations. A preview distance Lp is provided by a product of the preview period tp and the vehicle speed V. The predicted passing position Pf is a position the preview distance Lp ahead of the current position P0. As a modification, the control device 70 may calculate an expected traveling route based on the vehicle speed V and a steering angle of the wheel 2 and calculate the predicted passing position Pf based on the expected traveling route. In a case where the unsprung displacement map 200 is created for each traveling direction y, a predicted traveling direction of the vehicle 1 is also calculated in addition to the predicted passing position Pf.

In step S33, the processor 71 reads the unsprung displacement Zu at the predicted passing position Pf from the unsprung displacement map 200. In a case where the unsprung displacement map 200 is created for each traveling direction y, the unsprung displacement Zu is read from the unsprung displacement map 200 based on a combination of the predicted traveling direction and the predicted passing position Pf.

In step S34, the processor 71 resolves the unsprung displacement Zu into a left and right wheel in-phase input Zuin and a left and right wheel anti-phase input Zuan. The left and right wheel in-phase input Zufin and the left and right wheel anti-phase input Zufan on the front axle side are, for example, expressed by the following equations (1) and (2), and the left and right wheel in-phase input Zurin and the left and right wheel anti-phase input Zuran on the rear axle side are expressed by the following equations (3) and (4).

$$Zufin = \frac{Zufl + Zufr}{2} \qquad ( 1 )$$

$$Zufan = \frac{Zufl - Zufr}{2} \qquad ( 2 )$$

$$Zurin = \frac{Zurl + Zurr}{2} \qquad ( 3 )$$

$$Zuran = \frac{Zurl - Zurr}{2} \qquad ( 4 )$$

From equation (1) to equation (4), Zufl represents the unsprung displacement Zu of the front left wheel 2FL, and Zufr represents the unsprung displacement Zu of the front right wheel 2FR that constitutes the front wheels with the front left wheel 2FL. Zurl represents the unsprung displacement Zu of the rear left wheel 2RL, and Zurr represents the unsprung displacement Zu of the rear right wheel 2RR that constitutes the rear wheels with the rear left wheel 2RL.

In another example, the processor 71 further resolves the left and right wheel in-phase input Zuin into a front and rear wheel in-phase input (heave) Zuin resulting from vertical displacements that are the same between the front and rear wheels of the vehicle 1, and a front and rear wheel anti-phase input (pitch) Zuan resulting from vertical displacements that are different between the front and rear wheels. The front and rear wheels described here are a combination of the front left wheel 2FL and the front right wheel 2FR, and the rear left wheel 2RL and the rear right wheel 2RR. In this case, the resolved front and rear wheel in-phase input Zuin, that is, a left and right wheel in-phase and front and rear wheel in-phase input Zuin-in is expressed by the following equation (5). Further, the resolved front and rear wheel anti-phase input Zuan, that is, a left and right wheel in-phase and front and rear wheel anti-phase input Zuin-an is expressed by the following equation (6).

$$Zuin - in = \frac{Zufin + Zurin}{2} \qquad ( 5 )$$

$$Zuin - an = \frac{Zufin - Zurin}{2} \qquad ( 6 )$$

In step S35, the processor 71 determines whether or not additional filtering processing on the left and right wheel in-phase input Zufin on the front axle side and the left and right wheel in-phase input Zurin on the rear axle side is required. Specifically, the processor 71 determines that the additional filtering processing is required in a case where at least one of the following filter application condition (i) or (ii) is satisfied.
(i) The left and right wheel in-phase input Zuin (Zufin or Zurin) is equal to or greater than an upper limit value.
(ii) A moving average of the left and right wheel in-phase input Zuin (Zufin or Zurin) is equal to or greater than an upper limit value.

Note that the “upper limit value” is set in advance as the unsprung displacement Zu that exceeds capability of the actuator or the suspension stroke. Further, the moving average is, for example, calculated based on a plurality of left and right wheel in-phase inputs Zuin in a sampling period going back from the predicted passing position Pf. It is also possible to read the left and right wheel in-phase input Zuin at a future time ahead of the preview period tp from the unsprung displacement map 200 and use the left and right wheel in-phase input Zuin at a future time in calculation of the moving average.

In a case where it is determined in step S35 that the additional filtering processing is required (S35: Yes), the processing proceeds to step S36. In step S36, the processor 71 performs the additional filtering processing on the left and right wheel in-phase input Zuin. A second high-pass filter for cutting out a component equal to or less than a second frequency (for example, 0.5 Hz) resulting from elevation change, and the like, is applied to the left and right wheel in-phase input Zuin. This second high-pass filter is a high-pass filter stronger than the first high-pass filter used in the filtering processing in step S15 in FIG. 3. The “strong high-pass filter” described here means that a cut-off frequency (on a low frequency side) is high, a filter order is great or the number of stages of the filter is large.

As described above, the unsprung displacement Zu includes an extremely low frequency component (for example, a component equal to or less than 0.5 Hz) resulting from elevation change, and the like. However, this extremely low frequency component also includes a left and right wheel anti-phase input. Concerning this point, according to the processing routine indicated in FIG. 10, the additional filtering processing is performed on the left and right wheel in-phase input Zuin by step S34, S35 and S36. By this means, an extremely low frequency component resulting from elevation change, and the like, is cut out from the left and right wheel in-phase input Zuin. On the other hand, the additional filtering processing is not performed on the left and right wheel anti-phase input Zuan. Thus, a component higher than the first frequency (for example, 0.2 Hz) remains in the left and right wheel anti-phase input Zuan.

In a case of another example of step S34, in step S36, a third high-pass filter for cutting out a component equal to or less than a third frequency (for example, 0.5 Hz) resulting from elevation change, and the like, is applied to the left and right wheel in-phase and front and rear wheel in-phase input Zuin-in generated by resolution of the left and right wheel in-phase input Zuin. On the other hand, a fourth high-pass filter for cutting out a component equal to or less than a fourth frequency (for example, 0.4 Hz) is applied to the left and right wheel in-phase and front and rear wheel anti-phase input Zuin-an. In other words, the third high-pass filter is a high-pass filter stronger than the fourth high-pass filter. The fourth high-pass filter is a high-pass filter stronger than the first high-pass filter used in the filtering processing in step S15 in FIG. 3.

A reason why the relatively strong third high-pass filter is applied in the filtering processing on the left and right wheel in-phase and front and rear wheel in-phase input Zuin-in, and the relatively weak fourth high-pass filter is applied in the filtering processing of the left and right wheel in-phase and front and rear wheel anti-phase input Zuin-an is the same as a reason why different first high-pass filter and second high-pass filter are used.

In a case where it is determined in step S35 that the additional filtering processing is required, the processor 71 performs the additional filtering processing on the left and right wheel in-phase input Zuin in step S36. Otherwise, that is, in a case where it is determined in step S35 that the additional filtering processing is not required, the processing of the processor 71 proceeds to step S37 without the additional filtering processing being performed. However, the processor 71 may perform the additional filtering processing on the left and right wheel in-phase input Zuin. In this case, the second high-pass filter may be made a through-pass filter, or a fifth high-pass filter for cutting out a component equal to or less than a fifth frequency (for example, 0.3 Hz) may be used in the additional filtering processing. Note that the fifth filter is a high-pass filter weaker than the second high-pass filter.

In a case where the unsprung displacement Zu is calculated while the vehicle 1 is traveling, “phase shifting” occurs due to the filtering processing using the high-pass filter. Specifically, a “phase lead” occurs due to the high-pass filter. Thus, in step S37, the processor 71 adjusts the preview period tp such that a phase lag in accordance with a time constant of the high-pass filter applied in the additional filtering processing is canceled out. Specifically, the preview period tp is corrected to be shorter by an amount corresponding to the time constant of the high-pass filter to be applied. Thus, the preview period tp is corrected to be shorter as the time constant is smaller.

In step S38, the processor 71 calculates target control force Fc_t of the actuator 3A of the suspension 3 based on the unsprung displacement Zu at the predicted passing position Pf. The target control force Fc_t is, for example, calculated using the following equation (7) to equation (10).

$$Ffl = Zufin \cdot α fin + Zufan \cdot α fan \qquad ( 7 )$$

$$Ffr = Zufin \cdot α fin - Zufan \cdot α fan \qquad ( 8 )$$

$$Frl = Zurin \cdot α rin + Zuran \cdot α ran \qquad ( 9 )$$

$$Frr = Zurin \cdot α rin - Zuran \cdot α ran \qquad ( 10 )$$

From equation (7) to equation (10), Zufin and Zurin are the left and right wheel in-phase input Zuin subjected to the filtering processing using the second high-pass filter described in step S36 and the left and right wheel in-phase input Zuin passing through the second high-pass filter or the left and right wheel in-phase input Zuin subjected to the filtering processing using the fifth high-pass filter. Further, αfin is a left and right wheel in-phase input gain on the front axle side, αfan is a left and right wheel anti-phase input gain on the front axle side, αrin is a left and right wheel in-phase input gain on a rear axle side, and αran is a left and right wheel anti-phase input gain on the rear axle side.

In a case where the left and right wheel in-phase input Zuin is resolved, in equation (7) and equation (8), the “left and right wheel in-phase input Zufin” is read as the “left and right wheel in-phase and front and rear wheel in-phase input Zuin-in”, the “left and right wheel anti-phase input Zufan” is read as the “left and right wheel in-phase and front and rear wheel anti-phase input Zuin-an”, the “left and right wheel in-phase input gain αfin” is read as the “left and right wheel in-phase and front and rear wheel in-phase input gain αfrin”, and the “left and right wheel anti-phase input gain αfan” is read as the “left and right wheel in-phase and front and rear wheel anti-phase input gain αfran”. Further, in equation (9) and equation (10), the “left and right wheel in-phase input Zurin” is read as the “left and right wheel in-phase and front and rear wheel in-phase input Zuin-in”, the “left and right wheel anti-phase input Zuran” is read as the “left and right wheel in-phase and front and rear wheel anti-phase input Zurran”, the “left and right wheel in-phase input gain αrin” is read as the “left and right wheel in-phase and front and rear wheel in-phase input gain αfrin”, and the “left and right wheel anti-phase input gain αran” is read as the “left and right wheel in-phase and front and rear wheel anti-phase input gain αfran”.

In step S39, the control device 70 controls the actuator 3A so as to generate the target control force Fc_t at a timing at which the reference point of the vehicle position in the vehicle 1 passes through the predicted passing position Pf. The timing at which the reference point Pr passes through the predicted passing position Pf can be known from the preview period tp.

By the preview control utilizing the unsprung displacement map 200 described above, it is possible to effectively reduce vibration of the vehicle 1 (sprung structure 5). In particular, by using the unsprung displacement map 200 in which the left and right wheel anti-phase input remains in the time-series data of the unsprung displacement Zu and performing additional filtering processing as appropriate on the left and right wheel in-phase input acquired from the unsprung displacement map 200 while the vehicle 1 is traveling, it is possible to appropriately reflect the left and right wheel in-phase input Zuin and the left and right wheel anti-phase input Zuan in the damping control.

What is claimed is:

1. A method for performing damping control of a vehicle using a control map, to be executed by a computer,
the control map including a parameter map representing a correspondence relationship between a position and a parameter related to vertical motion of each wheel of the vehicle,
the parameter map being created or updated through filtering processing performed on time-series data of the parameter related to the vertical motion of each wheel of the vehicle,
the filtering processing including filtering processing using a first high-pass filter that cuts out a frequency component equal to or less than a first frequency from the parameter related to the vertical motion of each wheel of the vehicle, and
the method comprising:
calculating a predicted passing position of each wheel of the vehicle after a preview period from a current time while the vehicle is traveling;
acquiring the parameter related to the vertical motion of each wheel at the predicted passing position of each wheel of the vehicle from the parameter map;
calculating a left and right wheel in-phase input resulting from vertical displacements that are the same between a first wheel of the vehicle and a second wheel of the vehicle which constitutes left and right wheels with the first wheel, based on a parameter related to vertical motion of the first wheel at the predicted passing position of the first wheel and a parameter related to vertical motion of the second wheel at the predicted passing position of the second wheel;
calculating a left and right wheel anti-phase input resulting from vertical displacements that are different between the first wheel and the second wheel based on the parameter related to the vertical motion of the first wheel at the predicted passing position of the first wheel and the parameter related to the vertical motion of the second wheel at the predicted passing position of the second wheel; and
calculating each control amount of an actuator configured to control suspension strokes of the first wheel and the second wheel based on the left and right wheel anti-phase input of the first wheel and the second wheel and the left and right wheel in-phase input of the first wheel and the second wheel.

2. The method according to claim 1, further comprising:
determining whether or not additional filtering processing on the left and right wheel in-phase input of the first wheel and the second wheel is required,
wherein the additional filtering processing includes filtering processing using a second high-pass filter that cuts out a frequency component equal to or less than a second frequency higher than the first frequency from the left and right wheel in-phase input of the first wheel and the second wheel, and
the method further includes, in a case where it is determined that the additional filtering processing is required, calculating each control amount of the actuator configured to control the suspension strokes of the first wheel and the second wheel based on the left and right wheel anti-phase input of the first wheel and the second wheel and the left and right wheel in-phase input of the first wheel and the second wheel subjected to filtering processing that includes the additional filtering processing.

3. The method according to claim 2, wherein:
determining whether or not the additional filtering processing on the left and right wheel in-phase input of the first wheel and the second wheel is required includes determining whether or not a filter application condition is satisfied; and
determining whether or not the filter application condition is satisfied includes determining that the filter application condition is satisfied in a case where at least one of a condition that the left and right wheel in-phase input of the first wheel and the second wheel is equal to or greater than an upper limit value or a condition that a moving average of the left and right wheel in-phase input of the first wheel and the second wheel is equal to or greater than an upper limit value, is satisfied.

4. The method according to claim 2, further comprising:
decreasing the preview period such that a phase lead of the left and right wheel in-phase input of the first wheel and the second wheel is canceled out, the phase lead being in accordance with a time constant of the second high-pass filter used in the additional filtering processing.

5. The method according to claim 1, further comprising:
calculating a left and right wheel in-phase input resulting from vertical displacements that are the same between a third wheel of the vehicle, which constitutes front and rear wheels with the first wheel and the second wheel, and a fourth wheel of the vehicle, which constitutes left and right wheels with the third wheel, based on a parameter related to vertical motion of the third wheel at the predicted passing position of the third wheel and a parameter related to vertical motion of the fourth wheel at the predicted passing position of the fourth wheel;
calculating a left and right wheel anti-phase input resulting from vertical displacements that are different between the third wheel and the fourth wheel based on the parameter related to the vertical motion of the third wheel at the predicted passing position of the third wheel and the parameter related to the vertical motion of the fourth wheel at the predicted passing position of the fourth wheel;
calculating a left and right wheel in-phase and front and rear wheel in-phase input resulting from vertical displacements that are the same between the first wheel and the second wheel and are the same between the first wheel and the second wheel, and the third wheel and the fourth wheel, based on the left and right wheel in-phase input of the first wheel and the second wheel and the left and right wheel in-phase input of the third wheel and the fourth wheel; and
calculating a left and right wheel in-phase and front and rear wheel anti-phase input resulting from vertical displacements that are the same between the first wheel and the second wheel and are different between the first wheel and the second wheel, and the third wheel and the fourth wheel, based on the left and right wheel in-phase input of the first wheel and the second wheel and the left and right wheel anti-phase input of the third wheel and the fourth wheel,
wherein calculating each control amount of the actuator that controls the suspension strokes of the first wheel and the second wheel includes calculation of a control amount based on the left and right wheel anti-phase input of the first wheel and the second wheel and the left and right wheel in-phase and front and rear wheel in-phase input, and calculation of a control amount based on the left and right wheel anti-phase input of the first wheel and the second wheel and the left and right wheel in-phase and front and rear wheel anti-phase input.

6. The method according to claim 5, further comprising:
determining whether or not additional filtering processing on the left and right wheel in-phase input of the first wheel and the second wheel is required,
wherein the additional filtering processing includes filtering processing using a second high-pass filter that cuts out a frequency component equal to or less than a second frequency higher than the first frequency from the left and right wheel in-phase input of the first wheel and the second wheel,
wherein determining whether or not the additional filtering processing on the left and right wheel in-phase input of the first wheel and the second wheel is required includes:
determining whether or not additional filtering processing on the left and right wheel in-phase and front and rear wheel in-phase input is required; and
determining whether or not additional filtering processing on the left and right wheel in-phase and front and rear wheel anti-phase input is required, and
the method further includes, in a case where it is determined that the additional filtering processing is required, calculating each control amount of the actuator configured to control the suspension strokes of the first wheel and the second wheel based on the left and right wheel anti-phase input of the first wheel and the second wheel, the left and right wheel in-phase and front and rear wheel in-phase input subjected to filtering processing that includes the additional filtering processing, the left and right wheel anti-phase input of the first wheel and the second wheel, and the left and right wheel in-phase and front and rear wheel anti-phase input subjected to filtering processing that includes the additional filtering processing.

7. The method according to claim 6, wherein:
the additional filtering processing on the left and right wheel in-phase and front and rear wheel in-phase input includes filtering processing using a third high-pass filter that cuts out a frequency component equal to or less than a third frequency higher than the first frequency; and
the additional filtering processing on the left and right wheel in-phase and front and rear wheel anti-phase input includes filtering processing using a fourth high-pass filter that cuts out a frequency component equal to or less than a fourth frequency between the first frequency and the third frequency.

8. The method according to claim 7, further comprising:
decreasing the preview period such that a phase lead of the left and right wheel in-phase and front and rear wheel in-phase input is canceled out, the phase lead being in accordance with a time constant of the third high-pass filter used in the additional filtering processing performed on the left and right wheel in-phase and front and rear wheel in-phase input.

9. The method according to claim 7, further comprising:
decreasing the preview period such that a phase lead of the left and right wheel in-phase and front and rear wheel anti-phase input is canceled out, the phase lead being in accordance with a time constant of the fourth high-pass filter used in the additional filtering processing performed on the left and right wheel in-phase and front and rear wheel anti-phase input.

10. A system configured to perform damping control of a vehicle using a control map, the system comprising:
an actuator configured to control a suspension stroke of each wheel of the vehicle;
one or a plurality of storage devices in which the control map is stored; and
one or a plurality of processors configured to perform damping control processing of the vehicle by controlling the actuator based on the control map, wherein:
the control map includes a parameter map representing a correspondence relationship between a position and a parameter related to vertical motion of each wheel of the vehicle;
the parameter map is created or updated through filtering processing on time-series data of the parameter related to the vertical motion of each wheel of the vehicle;
the filtering processing includes filtering processing of cutting out a frequency component equal to or less than a first frequency from the parameter related to the vertical motion of each wheel of the vehicle; and
the damping control processing includes:
calculating a predicted passing position of each wheel of the vehicle after a preview period from a current time while the vehicle is traveling;
acquiring a parameter related to vertical motion of each wheel at the predicted passing position of each wheel of the vehicle from the parameter map;
calculating a left and right wheel in-phase input resulting from vertical displacements that are the same between a first wheel of the vehicle and a second wheel of the vehicle which constitutes left and right wheels with the first wheel based on a parameter related to vertical motion of the first wheel at the predicted passing position of the first wheel and a parameter related to vertical motion of the second wheel at the predicted passing position of the second wheel;
calculating a left and right wheel anti-phase input resulting from vertical displacements that are different between the first wheel and the second wheel based on the parameter related to the vertical motion of the first wheel at the predicted passing position of the first wheel and the parameter related to the vertical motion of the second wheel at the predicted passing position of the second wheel; and
calculating each control amount of the actuator configured to control suspension strokes of the first wheel and the second wheel based on the left and right wheel anti-phase input of the first wheel and the second wheel and the left and right wheel in-phase input of the first wheel and the second wheel.

11. The system according to claim 10, wherein:
the damping control processing further includes
determining whether or not additional filtering processing on the left and right wheel in-phase input of the first wheel and the second wheel is required;
wherein the additional filtering processing includes filtering processing using a second high-pass filter that cuts out a frequency component equal to or less than a second frequency higher than the first frequency from the left and right wheel in-phase input of the first wheel and the second wheel; and
the damping control processing further includes, in a case where it is determined that the additional filtering processing is required, calculating each control amount of the actuator configured to control the suspension strokes of the first wheel and the second wheel based on the left and right wheel anti-phase input of the first wheel and the second wheel and the left and right wheel in-phase input of the first wheel and the second wheel subjected to filtering processing that includes the additional filtering processing.
